(19) United States
(12) Patent Application Publication
(10) Pub. No.: US 2026/0316373 A1
(43) Pub. Date: Oct. 15, 2026

(54) HEATING SECTION OF THE THERMOFORMING FURNACE

(71) Applicant: Tools Factory Spolka Jawna Agnieszka Poplawska, Robert Poplawski, Stefanowka (PL)

(72) Inventor: Robert Poplawski, Stefanowka (PL)

(21) Appl. No.: 19/483,902

(22) PCT Filed: May 22, 2024
(86) PCT No.: PCT/IB2024/054961

§ 371 Date: Nov. 12, 2025

(30) Foreign Application Priority Data
Jun. 21, 2023 (PL) P.445302
Jan. 23, 2024 (PL) W.131940

(51) Int. Cl. B29C 51/42

(52) U.S. Cl. CPC B29C 51/425; B29C 51/422

(57) ABSTRACT

The heating section of the thermoforming furnace for thermal forming of products, enables effective plasticization of the material depending on the size and shape of the product, the thickness of the plasticized material or its different colors by using at least one moving heating panel (15) with radiators (16) in the heating zone. The heating section of the thermoforming furnace has the form of a drawer, which has a rectangular support frame (1) with a running unit (2) and a drive unit (3) for moving the section. The supporting frame (1) has a separate heating zone frame (6) through a longitudinal beam (5), located perpendicular to the direction of movement of the section. The frame (6) of the heating zone is equipped with an active shaft (7) with a servo mechanism (8) and a passive shaft (10). The active shaft (7) is connected on both sides to the passive shaft (10) by driving belts (13, 13′) through gear wheels (14). Heating panels (15) with radiators (16) located at the bottom of the section are attached to the belts (13, 13′). Inside the frame (6) of the heating zone, between the heating panels (15), and the active shaft (7) and the passive shaft (10), a screen (18) is mounted, constituting a thermal shield for the heating section.

The subject of the invention is the heating section of a thermoforming furnace for thermoforming products, especially products made of thermoformable materials.

The heating section of a thermoforming furnace is known in the form of a drawer, which consists of a rectangular support frame with a running unit and a section movement drive unit with a power cable guide attached to it. The heating section has a rectangular heating field located on the opposite side of the section's drive unit, in which stationary radiators are mounted.

A frame assembly for forming a carpet with a plastic backing for the car floor is known from the American patent description U.S. Pat. No. 5,207,963. The frame assembly includes an open stand, a set of legs with wheels and flexible holding means mounted around the periphery of the open stand. The frame assembly with the liner blank, formally clamped in an open rack, is initially moved to the heating zone to soften the plastic backing and then moved to the forming zone.

A thermoforming machine is known from the European description EP1512517, into which thermal foils made of, PVC or polypropylene, for example are fed to the forming station. In order to deform the forming foil at the forming station, the foil is heated, which takes place in a heating station in front of the forming station, but in principle it can also be carried out directly at the forming station located on the upper part of the machine. To deform the heated molding foil, the upper molding tool and the first lower molding tool are synchronized with the movement of the molding foil running continuously through the molding station.

A machine for thermoforming plastic products, which includes a machine tool, is known from the Chinese description of utility model CN207273853. The upper part of the machine tool is successively equipped with furnace heating device, mold forming device and punching device, furnace heating device and mold. Both sides of the forming device and the punching device are connected by a chain clamp pull assembly. The furnace heating device is equipped with a first hydraulic cylinder, a furnace heating assembly and a bottom plate furnace heating from top to bottom. The furnace heating unit and the furnace heating bottom plate controller are controlled by a motor. The forming device is arranged from top to bottom. The second hydraulic cylinder, the upper forming die and the lower forming die are arranged successively from the bottom.

A device for thermoforming products is known from the Polish description of the invention PL217189, which includes a mechanism for transporting thermoforming foil, a foil heating furnace located above the transport mechanism, an upper mold and a lower mold placed in the punch, and a cutting mechanism. The lower form has knives mounted longitudinally at the bottom, parallel to each other. The knives are equally spaced from each other and arranged vertically. Behind the punch there is a cutting mechanism consisting of a presser, a pneumatic actuator and a drive. The presser is a frame with elastically mounted rollers at the bottom, and a pressure cylinder is attached in the middle of the frame. Preferably, the frame is replaceable. The distance between the rollers is equal to the distance between the knives mounted in the lower mould. The frame is mounted in joints that are placed in the handles. The handles at the other end are finished with clamps. The clamps slide along guides along the lower form. After forming, when the upper punch lifts up, the actuator moves the presser to the front of the lower mold. Then the rollers fall onto the knives and a pneumatic actuator pulls the presser by the lower form. During this time, the pressure cylinder presses the rollers against the knives, and the knives cut the formed thermoforming foil, creating elongated fittings.

The purpose of the invention was to develop a simple and functional design of the heating section of the thermoforming furnace, which will enable optimization of the costs of the material plasticization process in the thermoforming process and will allow for precise material plasticization process, in accordance with the selected parameters for a given product.

The essence of the heating section of the thermoforming furnace according to the invention, having the form of a drawer, which is a rectangular support frame with a driving unit and a section movement drive unit attached to it, together with a power cable guide, having a rectangular heating field with radiators located on the opposite side of the section drive unit, consists in this that the heating zone is placed in a moving frame separated from the rectangular supporting frame of the section by a longitudinal beam located perpendicular to the direction of movement of the section. The active shaft with a servo mechanism and the passive shaft located parallel to it are rotatably mounted in a separate frame. The active shaft is connected on both sides to the passive shaft with driving belts through gear wheels. At least one heating panel with radiators is attached to the driving belts, located at the bottom of the section, which is supported by straight guides. Inside the frame of the heating zone, between the heating panels and the active and passive shafts, there is a screen mounted as a thermal shield for the heating section.

It is advantageous when the active shaft with the servo mechanism is located along the shorter side of the heating zone frame, which is rotatably attached to the longitudinal, longer sides of the heating zone frame.

It is advantageous when the straight guides supporting the heating panel are attached to the longer sides of the heating zone frame.

It is advantageous when the active shaft with the servo mechanism is placed along a longitudinal beam located on the side of the drive unit, which is also the longer side of the heating zone frame, which is rotatably mounted to the shorter sides of the heating zone frame. This location of the active shaft allows the heating panels to move in the direction of movement of the heating section, which shortens the travel distance of the heating panels and thus shortens the heating time.

It is advantageous when the straight guides supporting the heating panel are attached to the shorter sides of the heating zone frame.

The heating section according to the invention, by using at least one moving heating panel with radiators in the heating zone, enables effective plasticization of the material depending on the size and shape of the product, the thickness of the plasticized material or its different colors.

The design of the section enables precise material plasticization process, in accordance with the parameters selected for a given product. Radiant heating can take place in specific, planned places instead of the entire furnace area.

The servo mechanism used allows reading the position of the heating section, which allows the operation of the infrared emitters to be properly and precisely controlled. This heating system uses percentage regulation of the heating power of each emitter. The possibility of individual temperature control for each emitters allows the correct plasticization of the material, especially in places closer to the pressing frame, where there are greater temperature losses due to the receipt of heat by the environment. The solution according to the invention significantly reduces the consumption of electricity needed to plasticize the material, reaching up to 50% compared to traditional heating system solutions. The savings result from the optimizing the heating process and form a significant reduction of the power installed in the furnaces, reaching from 55 to 75% depending on the size of the working field, caused by the reduction of the number of installed heating elements.

The subject of the invention is shown in an embodiment in the drawing, in which

FIG. 1 schematically shows the heating section of the thermoforming furnace in a perspective top view,

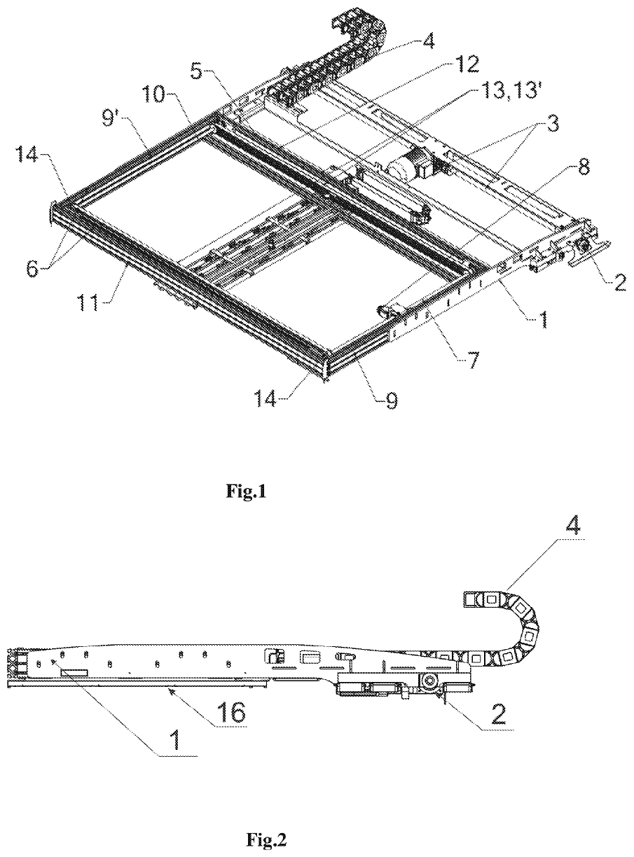

FIG. 2—schematically the section according to FIG. 1 in a side view,

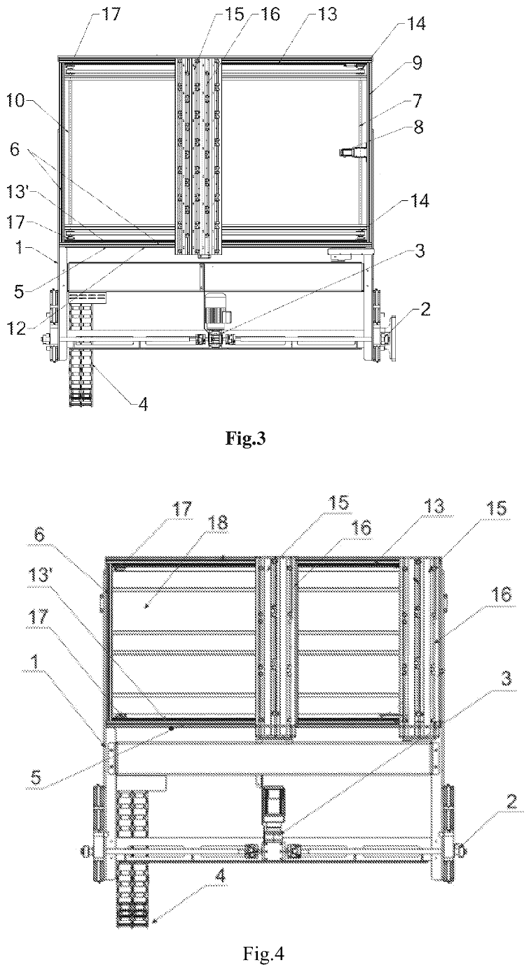

FIG. 3—schematically the section according to FIG. 1 with one heating panel in the bottom view, from the side of the material being plasticized,

FIG. 4—schematic of the section according to FIG. 1 with two heating panels in the bottom view, from the side of the material being plasticized,

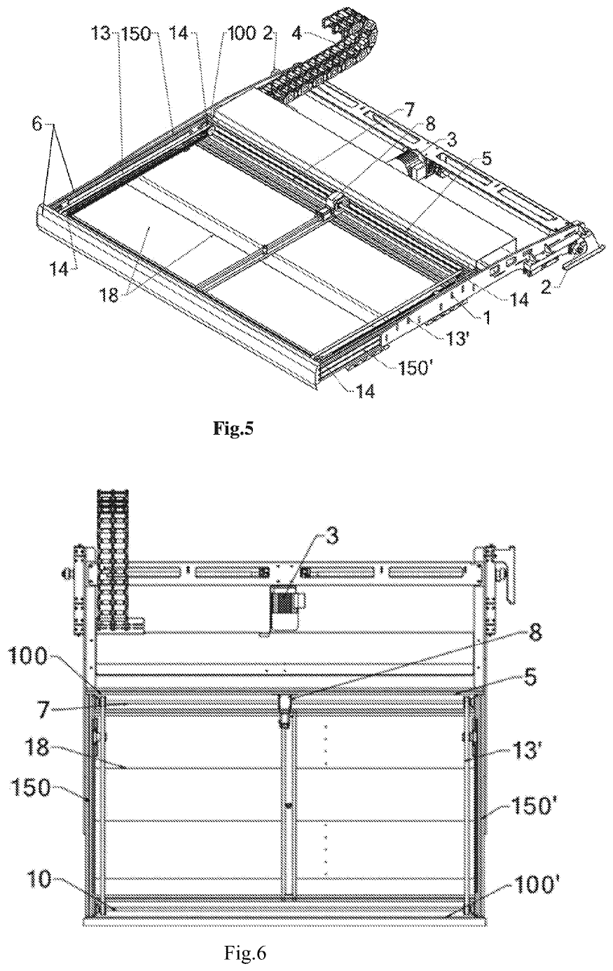

FIG. 5—variant of the construction of the heating section of the thermoforming furnace in a perspective view from above,

FIG. 6 schematically the heating section according to FIG. 5 in a top view,

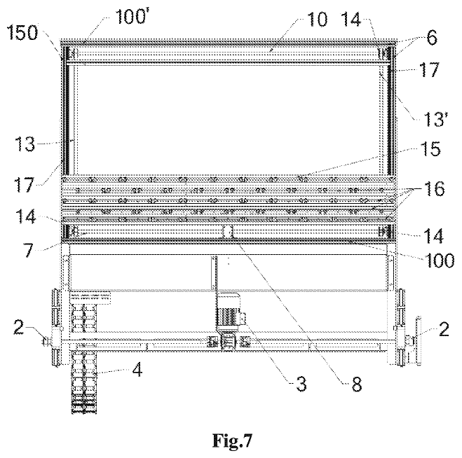

FIG. 7 schematically the heating section according to FIG. 5 with one heating panel in a bottom view, from the side of the plasticized material, and

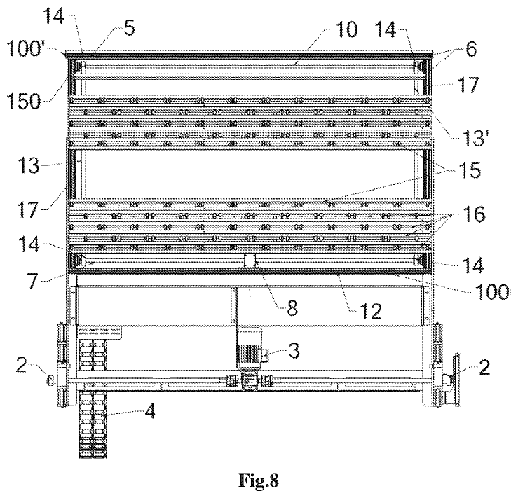

FIG. 8—schematic of the heating section according to FIG. 5 with two heating panels in a bottom view, from the side of the material being plasticized.

### EXAMPLE 1

The heating section of the thermoforming furnace shown in FIGS. 1 to 3 has a Form of a drawer that has a rectangular supporting frame 1 with a running unit 2 and a Section movement drive unit 3 attached to it along with a guide 4 for power cables. A Heating zone is located opposite the drive unit 3 for section. The supporting frame 1, Through a longitudinal beam 5, located perpendicular to the direction of movement of The section, has a separate heating field frame 6. The heating zone frame 6 is equipped With an active shaft 7 with a servo mechanism 8, located along the shorter side 9 of the Heating zone frame 6, and a passive shaft 10 located along the opposite shorter side 9′ of The heating zone frame 6. Both shafts 7 and 10 are rotatably mounted to the Longitudinal, longer sides 11 and 12 of the frame 6 of the heating zone, with the active Shaft 7 connected on both sides to the passive shaft 10 by driving belts 13, 13′ through Gears 14. To the driving belts 13 and 13′ a heating panel 15 with radiators 16 is Mounted, located at the bottom of the section. The heating panel 15 is supported by Straight guides 17 attached with their ends to the shorter sides 9 and 9′ of the frame 6 of The heating zone. Inside the frame 6 of the heating zone, between the heating panel 15, The active shaft 7 and the passive shaft 10, a screen 18 is mounted, constituting a Thermal shield for the heating section.

### EXAMPLE 2

The heating section of the thermoforming furnace shown in FIG. 4 has a structure similar to the heating section from example 1, with the difference that two heating panels 15 are attached to the driving belts 13 and 13′.

### EXAMPLE 3

The heating section of the thermoforming furnace shown in FIG. 5 to FIG. 7 has the structure as in FIG. 1 to FIG. 3, with the difference that the active shaft 7 with a servo mechanism 8 is connected on both sides to the passive shaft 10 by driving belts 13 and 13′ through gear wheels 14 is rotated 90° to the left in the heating zone frame 6. In this version, the active shaft 7 with the servo mechanism 8 is placed along the longitudinal beam 5 located on the side of the drive unit 3, which is also the longer side 100 of the frame 6 of the heating zone, and the passive shaft 10 is located along the opposite longer side 100′ of the frame 6 of the heating zone, which are rotatably mounted to the shorter sides 150 and 150′ of the frame 6 of the heating zone.

Straight guides 17 supporting the heating panel 15 are attached to the shorter sides 150 and 150′ of the frame 6 of the heating zone.

### EXAMPLE 4

The heating section of the thermoforming oven shown in FIG. 8 has a structure similar to the heating section from example 3, with the difference that two heating panels 15 are attached to the driving belts 13 and 13′.

### LIST OF SYMBOLS IN THE DRAWING

1. Support frame.
2. Running unit.
3. Drive unit.
4. Power cable guide.
5. Longitudinal beam.
6. Separate heating zone frame.
7. Active shaft.
8. Servo mechanism.
9, 9′. Shorter sides of the heating zone frame.
10. Passive shaft.
11, 12. Longitudinal, longer sides of the heating zone frame.
13, 13′. Drive belts.
14. Gears.
15. Heating panels.
16. Radiant heaters.
17. Guides.
18. Screen.
100, 100′. Longitudinal, longer sides of the heating zone frame.
150, 150′. Shorter sides of the heating zone frame.

1.-5. (canceled)

6. A thermoforming furnace comprising:
a heating section in form of a drawer;
a rectangular support frame;
a driving unit and a section movement drive unit attached to the rectangular support frame;
a power cable guide;
a rectangular heating zone with radiators located opposite the section drive unit;
wherein the heating zone is placed in a frame separated from the rectangular support frame of the heating section by a longitudinal beam located perpendicular to a direction of movement of the heating section;
an active shaft having a servo mechanism rotatably mounted and located parallel to a passive shaft, the active shaft being connected on both sides to the passive shaft by driving belts through gears;
at least one movable heating panel with radiators attached to the driving belts, the movable heating panel being located at a bottom of the heating section and supported by substantially straight guides; and
a screen attached inside the frame of the heating zone, between the movable heating panels and the active shaft and passive shaft, the screen constituting a thermal of the heating section.

7. The thermoforming furnace of claim 6, wherein in the heating section the active shaft with the servo mechanism is located along a shorter side of the frame of the heating zone, the active shaft being rotatably mounted to longitudinal longer sides of the frame of the heating zone, and the substantially straight guides supporting the movable heating panel are attached to the longer sides of the frame of the heating zone.

8. The thermoforming furnace of claim 6, wherein in the heating section the active shaft with the servo mechanism is placed along the longitudinal beam located on the side of the drive unit, the longitudinal beam constituting a longer side of the frame of the heating zone, the active shaft being rotatably mounted to shorter sides of the frame of the heating zone, and the straight guides supporting the movable heating panel are attached to the shorter sides of the frame of the heating section.
